(19) United States
(12) Patent Application Publication
(10) Pub. No.: US 2025/0111407 A1
(43) Pub. Date: Apr. 3, 2025

(54) PROVIDING TARGETED CONTENT BASED ON ACTIVE CONTENT SHARING APPLICATIONS AND CURRENT TIME

(71) Applicant: International Business Machines Corporation, Armonk, NY (US)

(72) Inventors: Kushal S. PATEL, Pune (IN); Gandhi SIVAKUMAR, Mountain View, CA (US); Sarvesh S. PATEL, Pune (IN)

(21) Appl. No.: 18/477,541

(22) Filed: Sep. 28, 2023

(51) Int. Cl. G06Q 30/0251; G06Q 30/0241; G06Q 30/0272

(52) U.S. Cl. CPC G06Q 30/0256; G06Q 30/0272; G06Q 30/0277

(57) ABSTRACT

A device may navigate to a website using a browser and may receive, based on navigating to the website, targeted content that is targeted based on browsing information. The device may receive, based on navigating to the website and at a particular time, a request to provide the targeted content via the browser. The device may determine whether content, on a display of the device, is being shared. The device may determine a period of time for providing a content type of the targeted content and may determine whether the particular time is included in the period of time based on determining whether the content is being shared. The device may provide the targeted content when the particular time is included in the period of time or may prevent the targeted content from being provided when the particular time is not included in the period of time.

### BACKGROUND

The present invention relates to providing content, and for example, relates to providing targeted content based on whether a content sharing application is active and based on a current time. A user may use a web browser, of a device, to browse content on the Internet. The content may be of different content categories. The web browser may be used to browse content on various websites and at various times of the day.

In some situations, a content server may cause supplemental content to be provided via the web browser (or also referred to as “browser”). For example, as the user browses content on a website, the content server may cause the supplemental content to be provided via the browser in addition to the content on the website. In some situations, the supplemental content may be targeted content. For example, the supplemental content may be based on browsing history of the user. For instance, the supplemental content may be based on the user using the web browser to browse content on one or more additional websites.

The supplemental content may be provided unexpectedly to the user. In other words, the supplemental content may be provided without a request from the user. In some situations, the supplemental content may be provided at a time when the user is engaged in activities that prevent the user from viewing the supplemental content. Accordingly, the content server may unnecessarily consume computing resources to identify the supplemental content, storage resources to store the supplemental content, and/or network resources to provide the supplemental content to the device.

In some situations, the supplemental content may be provided as the device is executing a content sharing application. For example, the supplemental content may be provided as the device is executing a video conferencing application. The video conferencing application may be sharing the content, provided via the web browser, with one or more additional devices. Accordingly, in some situations, the supplemental content may be shared unexpectedly with the one or more additional devices.

In some situations, the supplemental content may be private content and/or confidential content (of the user) that is not to be shared with the one or more additional devices. Accordingly, the user may cause the device to terminate execution of the video communication application and/or terminate execution of the browser to protect the privacy of the user.

Subsequently, after the supplemental content has been removed from the browser, the user may cause the device to resume execution of the video communication application and/or execution the browser. For example, the device may utilize resources to re-establish a connection, via a network, to the content server. The device may terminate and resume execution of the video communication application and/or execution of the browser each time supplemental content is provided unexpectedly.

When terminating and resuming the execution of the video communication application, the device may cause resources to be deallocated and to be reallocated. Accordingly, the device may unnecessarily consume resources that are used to terminate and resume the execution of the video communication application. For example, the device may cause computing resources and/or network resources to be deallocated and to be reallocated. Accordingly, there is a need to improve a manner in which the supplemental content is provided to the device.

### SUMMARY

A computer-implemented method, for providing targeted content, the computer-implemented method comprising: navigating to a website using a browser of a device; receiving, based on navigating to the website, targeted content that is targeted based on browsing information; receiving, based on navigating to the website and at a particular time, a request to provide the targeted content via the browser; determining whether content, on a display of the device, is being shared with one or more additional devices; determining a period of time for providing a content category of the targeted content; determining whether the particular time is included in the period of time based on determining whether the content is being shared; and selectively providing the targeted content based on determining whether the current time is included in the period of time, the targeted content being provided when the current time is included in the period of time, and the targeted content being prevented from being provided when the current time is not included in the period of time.

An advantage of determining that the content, on the display of the device, is not being shared with the one or more additional devices prior to determining when the targeted content can be shared is to prevent unintentional disclosure of content that is private and/or confidential to a user of the device. Accordingly, an advantage of determining that the content, on the display of the device, is not being shared is to protect the privacy of the user.

An additional advantage of determining that the content, on the display of the device, is not being shared with the one or more additional devices prior to determining when the targeted content can be shared is to prevent repeatedly and/or successively terminating and resuming executions of the applications of the device. The applications may include an application that shares content with other devices via a network, such as a video conferring application. Accordingly, an advantage of determining that the content is not being shared is to prevent computing resources and/or network resources from being repeatedly and/or successively de-allocated and reallocated.

An advantage of preventing the targeted content from being shared until the current time is included in the period of time is to ensure that the user is not engaging in activities that prevent the user from accessing the targeted content. In other words, an advantage of preventing the targeted content from being shared until the current time is included in the period of time is to ensure that the content that the user accesses the targeted content (e.g., by viewing and/or listening) when the targeted content is provided to the device. Accordingly, an advantage of preventing the targeted content from being shared until the current time is included in the period of time is to prevent the content server from unnecessarily consuming computing resources to identify the targeted content, storage resources to store the targeted content, and/or network resources to provide the targeted content to the device.

A computer program product comprising: one or more computer readable storage media, and program instructions collectively stored on the one or more computer readable storage media, the program instructions may comprise program instructions to program instructions to receive a request to provide, to a device, targeted content that is targeted based on browsing history associated with the device; program instructions to determine applications executing on the device; program instructions to determine whether at least one of the applications is sharing content, on a display of the device, with one or more additional devices; and program instructions to selectively: prevent the targeted content from being provided when the at least one of the applications is sharing content on the display of the device with the one or more additional devices, and determine a period of time for providing a content category of the targeted content when the at least one of the applications is not sharing content on the display of the device with the one or more additional devices.

An advantage of determining that the at least one of the applications is not sharing content on the display of the device with the one or more additional devices prior to determining when the targeted content can be shared is to prevent unintentional disclosure of content that is private and/or confidential to a user of the device. Accordingly, an advantage of determining that the at least one of the applications is not sharing content on the display of the device is to protect the privacy of the user.

An additional advantage of determining that the at least one of the applications is not sharing content on the display of the device prior to determining when the targeted content can be shared is to prevent repeatedly and/or successively terminating and resuming executions of the applications of the device. The applications may include an application that shares content with other devices via a network, such as a video conferring application. Accordingly, an advantage of determining that the at least one of the applications is not sharing content on the display of the device is to prevent computing resources and/or network resources from being repeatedly and/or successively de-allocated and reallocated.

An advantage of determining whether a current time is included in the period of time is to ensure that the user is not engaging in activities that prevent the user from accessing the targeted content. In other words, an advantage of determining whether a current time is included in the period of time is to ensure that the user accesses the targeted content (e.g., by viewing and/or listening) when the targeted content is provided to the device. Accordingly, an advantage of determining whether a current time is included in the period of time is to prevent the content server from unnecessarily consuming computing resources to identify the targeted content, storage resources to store the targeted content, and/or network resources to provide the targeted content to the device.

An advantage of providing the targeted content based on determining that the current time is included in the period of time is to ensure that the user is not engaging in activities that prevent the user from accessing the targeted content. Accordingly, an advantage of providing the targeted content based on determining that the current time is included in the period of time is to prevent the content server from unnecessarily consuming computing resources to identify the targeted content, storage resources to store the targeted content, and/or network resources to provide the targeted content to the device.

A system comprising: a device may be configured to: a device configured to: receive a request to provide, on a display of the device, targeted content that is targeted based on content previously accessed by the device or by another device associated with the device; determine applications executing on the device; determine whether at least one application of the applications is an application is sharing content, on the display, with one or more additional devices; and selectively: determine that the targeted content is not to be provided on the display when the at least one application is sharing content on the display with the one or more additional devices, and determine a period of time for providing a content category of the targeted content when the at least one application is not sharing content on the display with the one or more additional devices.

An advantage of determining that the at least one application is not sharing content on the display with the one or more additional devices prior to determining the period of time for sharing the targeted content is to prevent unintentional disclosure of content that is private and/or confidential to a user of the device. Accordingly, an advantage of determining that the at least one application is not sharing content is to protect the privacy of the user.

An additional advantage determining that the at least one application is not sharing content prior to determining the period of time for sharing the targeted content is to prevent repeatedly and/or successively terminating and resuming executions of the applications of the device. The applications may include an application that shares content with other devices via a network, such as a video conferring application. Accordingly, an advantage of determining that the at least one application is not sharing content is to prevent computing resources and/or network resources from being repeatedly and/or successively de-allocated and reallocated.

### BRIEF DESCRIPTION OF THE DRAWINGS

FIG. 1 is a diagram of an example implementation of user device described herein.

FIG. 2 is a diagram of an example implementation of content device described herein.

FIGS. 3A-3G are diagrams of an example implementation described herein.

FIG. 4 is a diagram of an example computing environment in which systems and/or methods described herein may be implemented.

FIG. 5 is a diagram of example components of one or more devices of FIG. 1.

FIG. 6 is a flowchart of an example process associated with providing targeted content.

### DETAILED DESCRIPTION

The following detailed description of example implementations refers to the accompanying drawings. The same reference numbers in different drawings may identify the same or similar elements.

Implementations described herein are directed to providing targeted content to a device based on determining whether the device is sharing content on a display of the device and based on a current time. In other words, implementations described herein may prevent the targeted content from being provided on a display of the device when content, provided on the display, is being shared with another device or being projected on another device. Additionally, or alternatively, implementations described herein may enable the targeted content to be provided at a time of the day that ensures that a user, of the device, will view and/or listen to the targeted content. In this regard, implementations described herein may determine different periods of time for providing different content types.

The term “targeted content” may be used to refer to content that is based on interests of a user of the device. The interests may refer to interest in one or more subject matters, one or more objects, one or more items, and/or one or more topics, among other examples. The targeted content may be received from a targeted content device.

The targeted content may include audio content, image content, and video content. In some examples, the targeted content may be provided with content being provided on a display of the device. For instance, the targeted content may be provided as supplemental content to the content being provided on the display of the device.

In some examples, the targeted content may be provided during a web browsing session. For instance, the device may be accessing content of a website using a browser (or browser application) and the targeted content may be provided, via the browser, with the content being accessed by the device during the web browsing. In this regard, implementations described herein may include a browser extension application that is configured to control when the targeted content is being provided via the browser after the targeted content is received from the content server.

Implementations described herein are directed to determining rules for providing the targeted content. The rules may identify the different periods of time for providing different content categories. In some examples, the rules may be determined based on event information regarding events associated with navigating to different web pages. The event information may identify a web page accessed using the device, content provided via the web pate, a content category of the content, and/or an amount of time spent on the web page, among other examples. Additionally, or alternatively, the rules may be determined based on timing information identifying a time at which the web page was accessed. For example, the timing information may include a timestamp associated with when the web page was accessed.

The rules may identify different periods of time for providing targeted content of different content categories. For example, a first rule may indicate that targeted content of a first content category are to be provided during a first period of time, a second rule may indicate that targeted content of a second content category are to be provided during a second period of time, and so on.

The first content category may be professional content (e.g., content related to an existing employment) and the first period of time may include typical work hours (e.g., from 9AM to 5PM). The second content category may be personal content (e.g., content related to a hobby) and the second period of time may include typical out-of-work hours (e.g., from 6PM to 8AM).

The rules may indicate that targeted content is not to be provided while the device is executing an application that shares content, on a display of the device, with one or more additional devices. While examples described herein may relate to navigating websites, implementations described herein are applicable to navigating different applications and/or applicable to accessing e-mails.

As explained herein, the targeted content may be masked or unmasked based on the rules for provided the targeted content and/or based on a time of day. In other words, implementations described herein may provide the targeted content or may prevent the targeted content from being provided based on the rules.

An advantage of determining that the content, on the display of the device, is not being shared with the one or more additional devices is to prevent unintentional disclosure of targeted content that is private and/or confidential to a user of the device. Accordingly, an advantage of determining that the content, on the display of the device, is not being shared is to protect the privacy of the user.

An additional advantage of determining that the content, on the display of the device, is not being shared with the one or more additional devices prior to determining when the targeted content can be shared is to prevent repeatedly and/or successively terminating and resuming executions of the applications of the device. The applications may include an application that shares content with other devices via a network, such as a video conferring application. Accordingly, an advantage of determining that the content is not being shared is to prevent computing resources and/or network resources from being repeatedly and/or successively de-allocated and reallocated.

An advantage of providing the targeted content based on determining that the current time is included in a period of time for providing the content category is to prevent the content server from unnecessarily consuming computing resources to identify the targeted content, storage resources to store the targeted content, and/or network resources to provide the targeted content to the device. An additional advantage of providing the targeted content based on determining that the current time is included in a period of time for providing the content category is to ensure that the targeted content is accessed instead of being ignored.

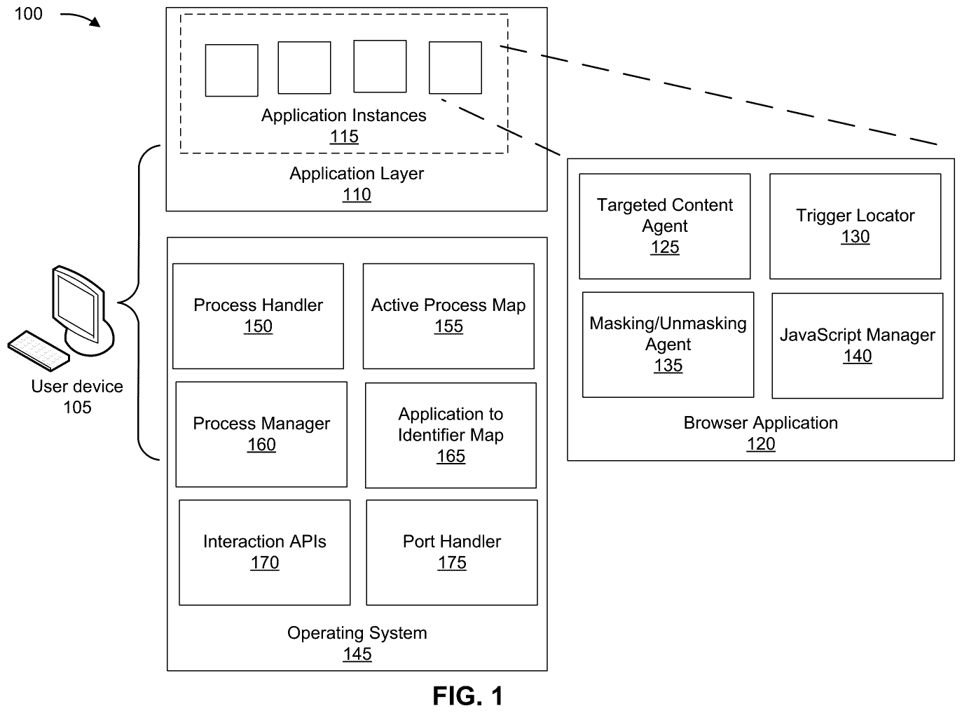

FIG. 1 is a diagram of an example implementation 100 of a user device described herein. As shown in FIG. 1, implementation 100 may include a user device 105.

User device 105 may include one or more devices configured to receive, generate, store, process, and/or provide information associated with selectively providing targeted content, as explained herein. As shown in FIG. 1, user device 105 may include an output component and an input component. The output component may include a display device and the input component may include a keyboard.

User device 105 may include a communication device and a computing device. For example, user device 105 may include a wireless communication device, a mobile phone, a user equipment, a laptop computer, a tablet computer, a desktop computer, and/or a similar type of device.

As shown in FIG. 1, user device 105 may include an application layer 110. As shown in FIG. 1, application layer 110 may include multiple application instances 115 (e.g., instances of applications executing on user device 105). For example, application instances 115 may include a browser application 120.

Browser application 120 may include a plurality of components such as a targeted content agent 125, a trigger locator 130, a masking/unmasking agent 135, and a JavaScript manager 140. Targeted content agent 125 may include one or more devices configured to obtain targeted content. In some situations, targeted content agent 125 may implement a data store configured to store targeted content information regarding websites that are accessed by user device 105. For example, the targeted content information of a website may include a date and/or a time when user device 105 accessed the website, a content category of content.

Trigger locator 130 may determine whether to cause (or trigger) the targeted content to be obtained from a content device and provided to user device 105. For example, trigger locator 130 may determine whether a particular time is a time that is suitable for providing the targeted content.

Masking/unmasking agent 135 may be configured to determine whether the targeted content is to be provided and/or determine whether the targeted content is to be saved.

JavaScript manager 140 may be configured to communicate with a content device to request the targeted content. In some situations, JavaScript manager 140 may be configured to cause the targeted content to be provided with content currently being provided by a display of user device 105.

As shown in FIG. 1, user device 105 may include an operating system layer 145 in addition to an application layer 110. As shown in FIG. 1, operating system layer 145 may include one or more components, such as a process handler 150, an active process map 155, a process manager 160, an application to identifier map 165, interaction application program interfaces 170, and a port handler 175.

Process handler 150 may be configured to perform one or more tasks for operating system layer 145. For example, process handler 150 may be configured to obtain information from application layer 110 and provide the information to one or more other components of operating system layer 145. For instance, process handler 150 may be configured to obtain information identifying one or more applications being executed by user device 105, such as an application that shares content provided by a display of user device 105.

Active process map 155 may be configured to map active processes (that are running on operating system 145) to parent processes of the active processes. For example, active process map 155 may map information identifying the active processes (e.g., first identifiers identifying the active processes) to information identifying the parent processes (e.g., second identifiers identifying the parent processes). Active process map 155 may map an identifier (e.g., 1234) of a first active process to an identifier (e.g., 4567) of a parent process of the first active process, map an identifier (e.g., 1235) of a second active process to an identifier (e.g., 4568) of a parent process of the second active process, map an identifier (e.g., 1236) of a third active process to an identifier (e.g., 4569) of a parent process of the third active process, and so on. For example, active process map 155 may be configured to identify an identifier (e.g., 2345) of a process of a video conferencing application.

Process manager 160 may include a function configured to identify active processes that are running on operating system layer 145. For example, process manager 160 may be configured to generate an inquiry to identify the active processes and the parent processes and may provide a response to the inquiry to active process map 155. The response may include the information identifying the active processes and the information identifying the parent processes.

Application to identifier map 165 may be configured to map a name or a title of an application to an identifier of a process associated with the application (e.g., an identifier of an instance of the application). For example, application to identifier map 165 may be configured to map a name of a first application (e.g., “video conferencing”) to an identifier (e.g., 2345) of a process associated with the first application, map a name of a second application (e.g., “calculator”) to an identifier (e.g., 2345) of a process associated with the second application, and so on.

Interaction application program interfaces (APIs) 170 include one or more APIs that are used to interact with the one or more additional devices. For example, interaction APIs 170 may be used to communicate with the one or more additional devices (e.g., communicate with a content server to obtain targeted content).

Port handler 175 may be configured to open and/or close ports to facilitate communication between user device 105 and one or more additional devices of a network associated with user device 105. As example, port handler 175 may open a port of user device 105 (e.g., port 8080) and user device 105 may communicate with the one or more additional devices via port 8080. For instance, user device 105 may obtain targeted content from the one or more additional devices via port 8080 (e.g., from a content server).

As indicated above, FIG. 1 is provided as an example. Other examples may differ from what is described with regard to FIG. 1. The number and arrangement of devices shown in FIG. 1 are provided as an example. There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

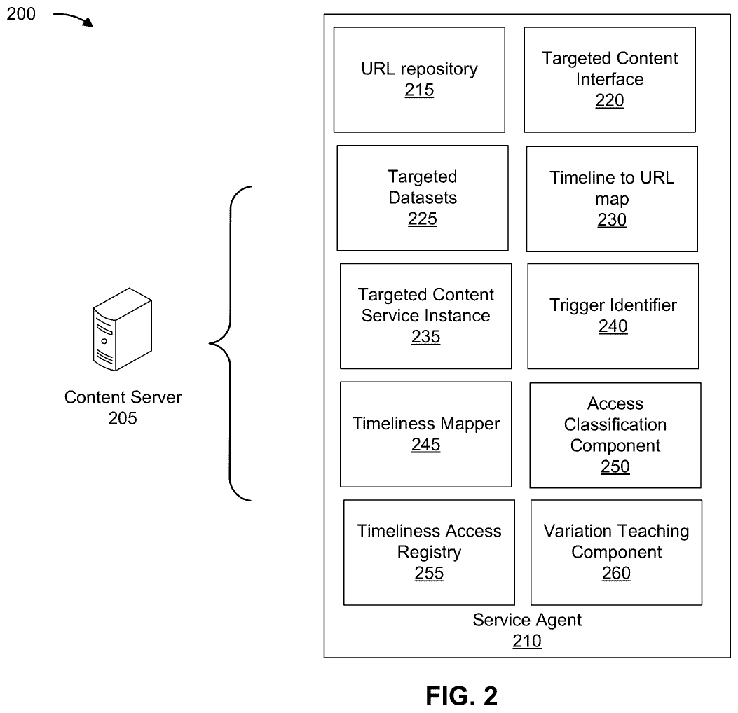

FIG. 2 is a diagram of an example implementation 200 of a content server described herein. As shown in FIG. 2, implementation 200 may include a content server 205. Content server 205 may include a server, such as an application server, a client server, a web server, a database server, a host server, a proxy server, a virtual server (e.g., executing on computing hardware), or a server in a cloud computing system.

As shown in FIG. 2, content server 205 may include a service agent 210. Service agent 210 may be configured to provide targeted content to user device 105 and provide code used by user device 105 to obtain the targeted content. As shown in FIG. 2, service agent 210 may include a uniform resource locator (URL) repository 215, a targeted content interface 220, targeted datasets 225, a timeline to URL map 230, a targeted content service instance 235, a trigger identifier 240, a timeliness mapper 245, an access classification component 250, a timeliness access registry 255, and a variation teaching component 260.

URL repository 215 may include a repository that stores information regarding URLs that are associated with targeted content. Targeted content interface 220 may be configured to add and/or remove code for providing the targeted content. Targeted datasets 225 may include targeted content that is based on browsing history. For example, targeted datasets 225 may include first targeted content that is based on first browsing history, second targeted content that is based on second browsing history, and so on.

Targeted content service instance 235 may be configured to generate code for obtaining and providing the targeted content. Trigger identifier 240 may be configured to identify triggers that cause service agent 210 to provide the targeted content to a browser of user device 105. Trigger identifier 240 may obtain information regarding the triggers from a browser. Access classification component 250 may be configured to monitor and/or identify access to the targeted content by one or more users. For example, a first user may have a first access level, a second user may have a second access level, and so on.

Timeliness access registry 255 may include a data store be configured to store URLs (e.g., of websites accessed by using user device 205). Variation teaching component 260 may be configured to provide feedback regarding whether the targeted content is provided by a display of user device 105. As indicated above, FIG. 2 is provided as an example. Other examples may differ from what is described with regard to FIG. 2. The number and arrangement of devices shown in FIG. 2 are provided as an example. There may be additional devices (e.g., a large number of devices), fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

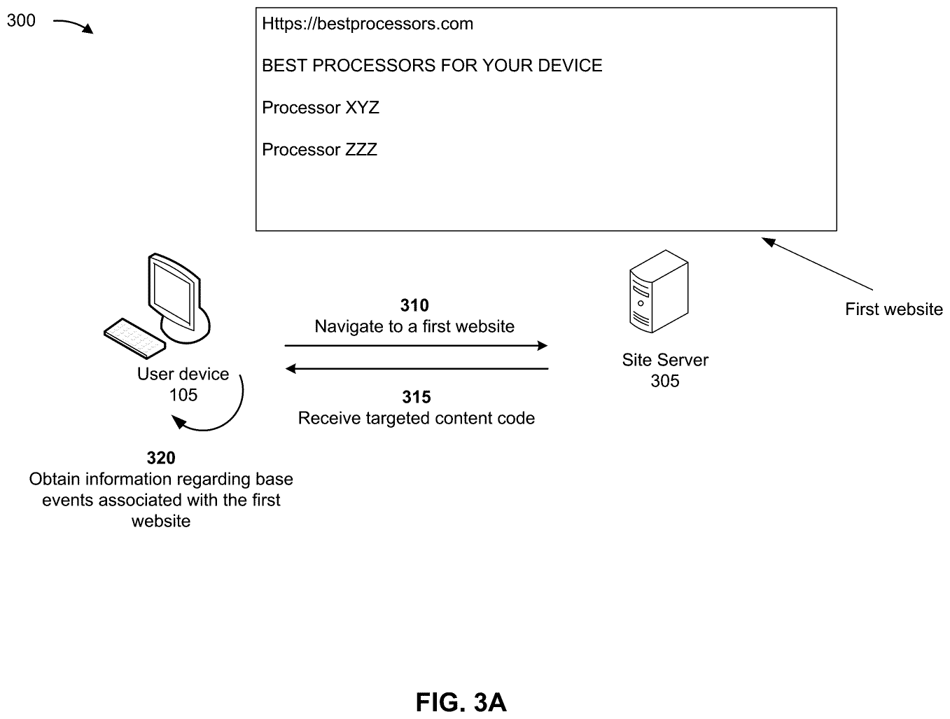

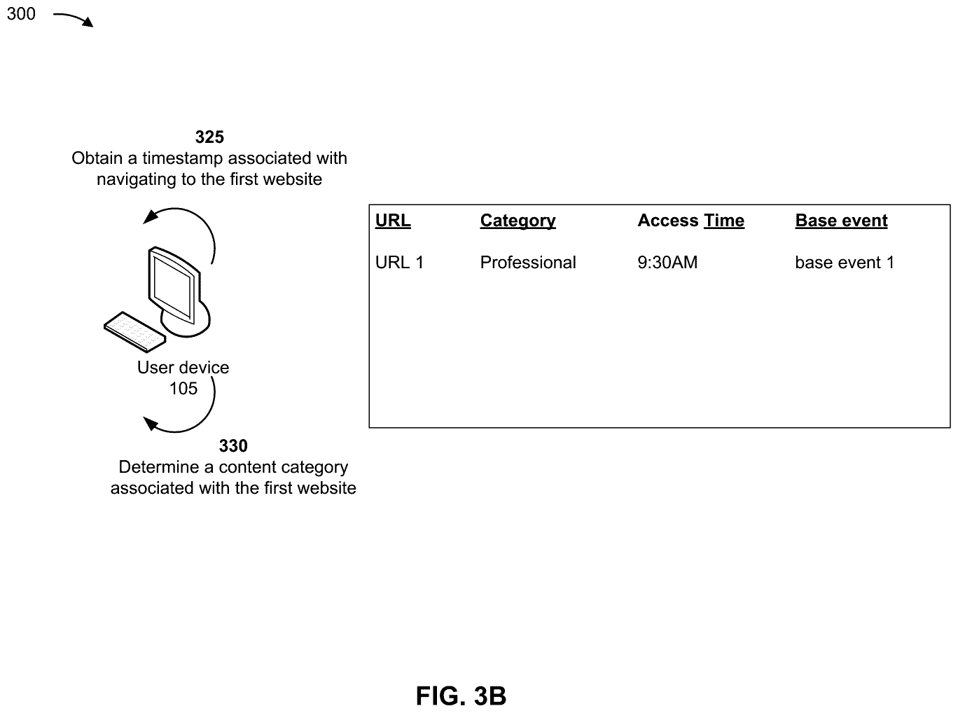

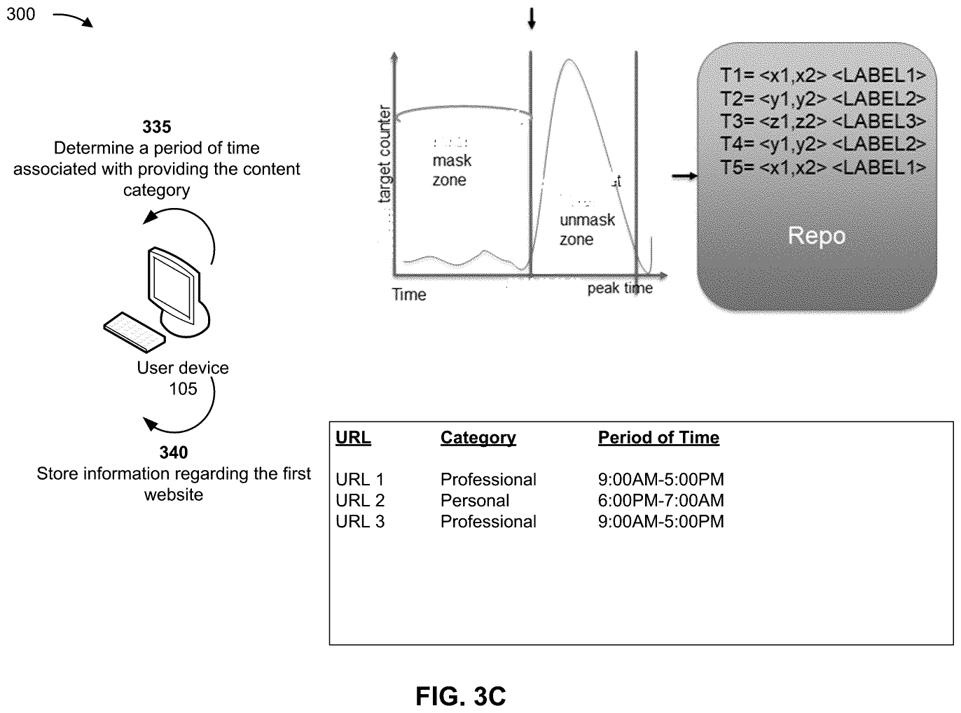

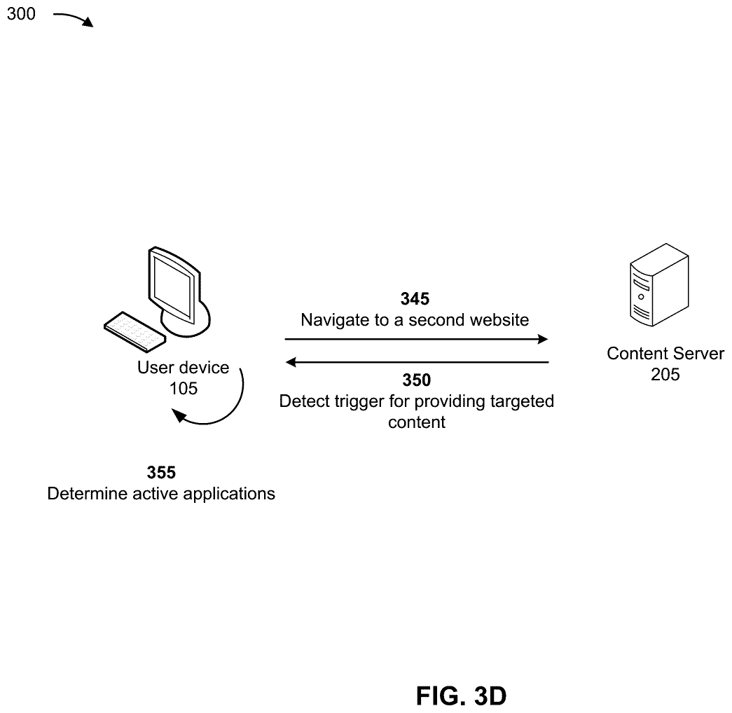

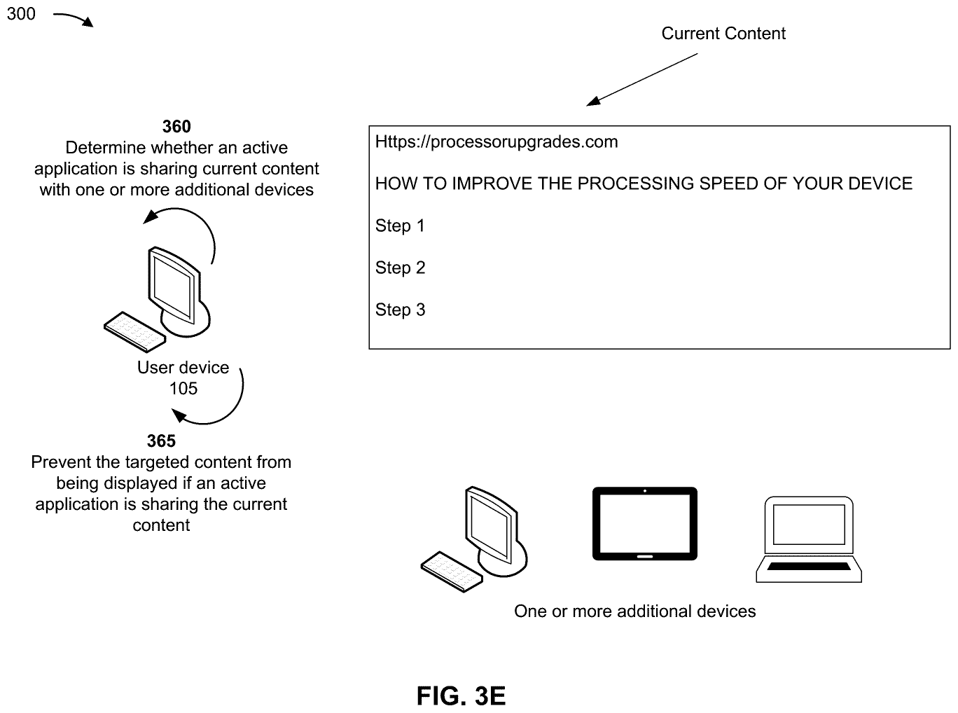

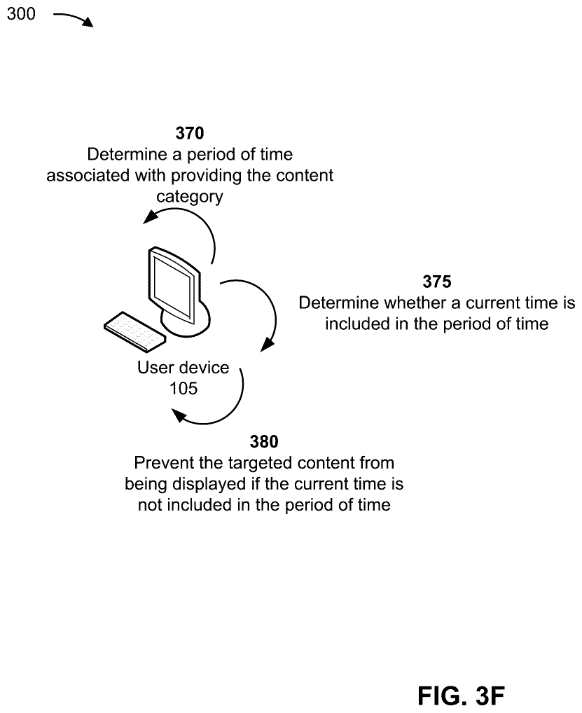

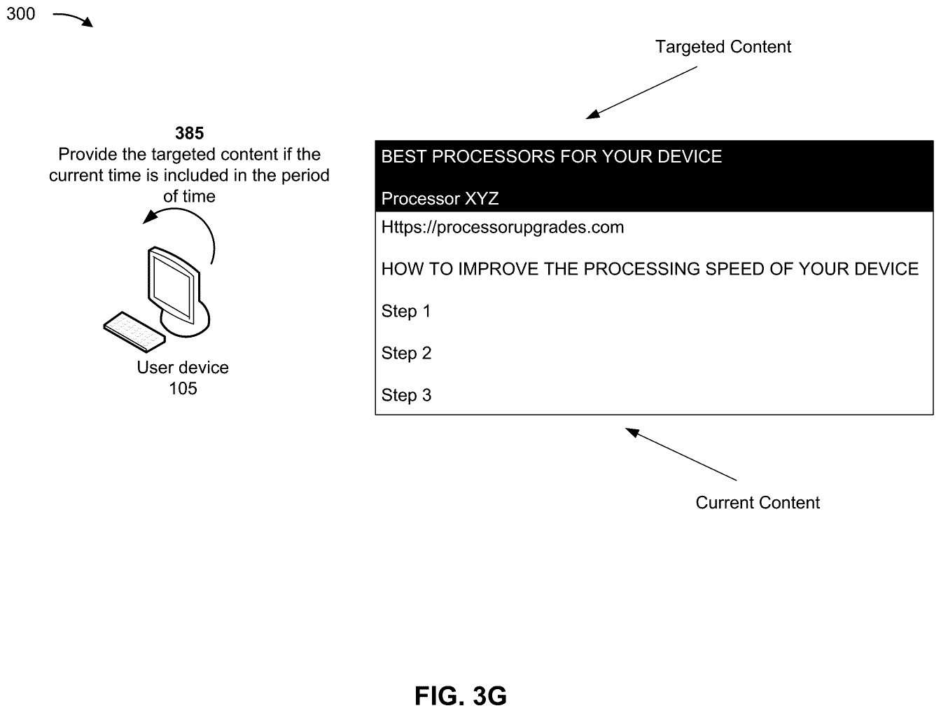

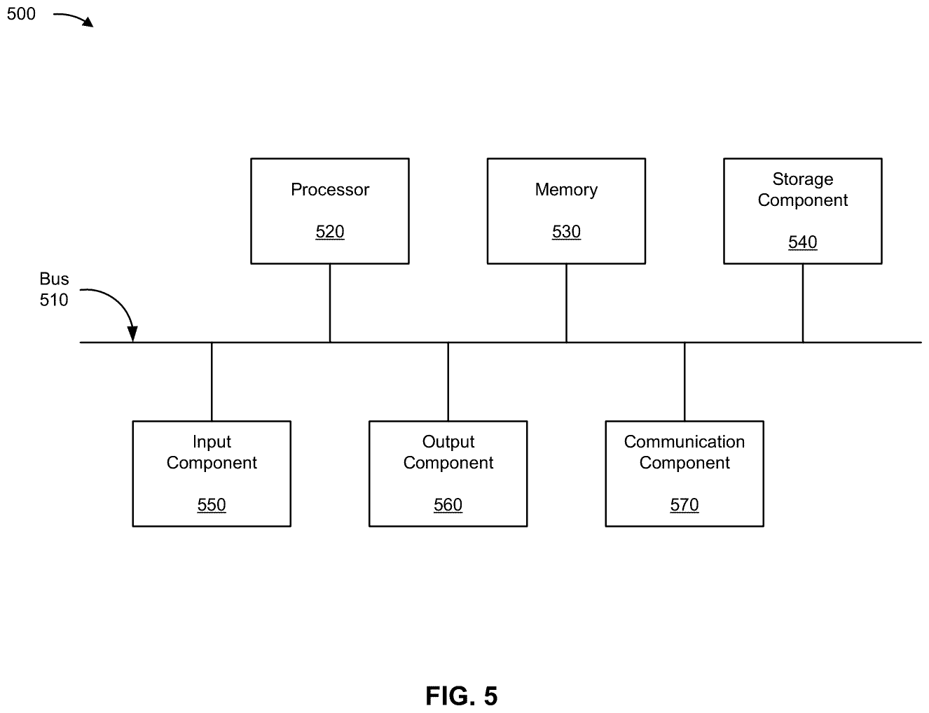

FIGS. 3A-3G are diagrams of an example implementation 100 described herein. As shown in FIGS. 3A-3G, example implementation 100 includes user device 105, content server 205, and a site server 305. These devices are described in more detail below in connection with FIG. 5.

The devices may be connected via a network that includes one or more wired and/or wireless networks. For example, the network may include Ethernet switches. Additionally, or alternatively, the network may include a cellular network, a public land mobile network (PLMN), a local area network (LAN), a wide area network (WAN), a private network, the Internet, and/or a combination of these or other types of networks.

The network enables communication between user device 105, content server 205, and site server 305. Site server 305 may include a server, such as an application server, a client server, a web server, a database server, a host server, a proxy server, a virtual server (e.g., executing on computing hardware), or a server in a cloud computing system.

As shown in FIG. 3A, and by reference number 310, user device 105 may navigate to a first website. For example, user device 105 may navigate to the first website using browser application 120. For instance, user device 105 may navigate to the first website using a link to the first website. In some situations, user device 105 may open a port to communicate with site server 305. User device 105 may open the port using port handler 175. User device 105 may transmit a request for content of the first website to site server 305.

As shown in FIG. 3A, and by reference number 315, user device 105 may receive targeted content code (e.g., code that is used to display the targeted content). For example, based on the request, user device 105 may receive the content of the first website from site server 305. For example, user device 105 may receive code for displaying the first website. The content of the first website may include the targeted content code. In some examples, the targeted content code may be used to obtain and store information regarding interactions of user device 105 with the first website. The information may be stored on a memory of user device 105 (e.g., a memory included in user device 105).

As shown in FIG. 3A, and by reference number 320, user device 105 may obtain information regarding base events associated with the first website. In some implementations, the “base events” may be used to refer to information regarding the interactions with the first website. For example, the base events may identify content accessed (or clicked on) by user device 105, an amount of time spent on the first website or on a webpage of the first website, and/or content previously accessed by user device 105 on the first website, among other examples.

In some implementations, the process running in the retargeting pixel selector initiates itself and loads information corresponding to a metadata repository, a browsing history and/or a catalog for operation associated with the browsing history. In some examples, the process initiates the instance which will poll for the pixel target. The target poll thread will wake up and look for the event. The process further collects the information about base events.

As shown in FIG. 3B, and by reference number 325, user device 105 may obtain a timestamp associated with navigating to the first website. For example, user device 105 may retrieve the timestamp from the data store of targeted content agent 125. In some situations, prior to storing the timestamp, user device 105 may obtain the timestamp at the time the targeted content code was received. The timestamp may be obtained by making a call to an operating system of user device 105 and may be stored in the data store. User device 105 may update an entry associated with navigating to the first website each the targeted content code is accessed. Based on the timestamp, user device 105 may determine a date and/or a time at which user device 105 navigated to the first website. Additionally, or alternatively, based on the timestamp, user device 105 may determine a date and/or a time at which user device 105 received the targeted content code.

Based on the timestamp, user device 105 may determine a period of time during which user device 105 typically accesses websites with particular content similar to the content of the first website (e.g., content of a same content category as the first website). For example, user device may obtain (from the data store of targeted content agent 125) information regarding the particular content and determine, based on the information, dates and/or times at which the websites were accessed.

As shown in FIG. 3B, and by reference number 330, user device 105 may determine a content category associated with the first website. In some implementations, user device 105 may determine the content category based on metadata describing the content of the first website. Additionally, or alternatively, user device 105 may determine the content category based on a description of the link to the first website. As an example, based on the metadata and/or the description of the link, user device 105 may determine that the content category is professional. For example, the first website may be providing content related to work/employment and/or related to professional development. Once the base events and the content category are determined, a new entry is logged in for the first website.

As shown in FIG. 3C, and by reference number 335, user device 105 may determine a period of time associated with providing content of the content category. In some implementations, user device 105 may analyze historical data time(s) and/or date(s) when content of the content category are typically accessed. As shown in FIG. 3C, the historical data may be in the format of a graph. In this regard, the graph may identify a period of time associated with accessing the content category and identify a period of time associated with not accessing the content category.

Additionally, or alternatively, user device 105 may determine a period of time associated with the content category. For example, user device 105 may determine a first period of time associated with work, determine a second period of time associated with personal/home, and so on. In some implementations, user device 105 may provide a unique identifier for user device 105, the event information, the timing information, and/or information identifying the content category to content.

As shown in FIG. 3D, and by reference number 345, user device 105 may navigate to a second website. For example, user device 105 may navigate to the second website in a manner similar to the manner in which user device 105 navigated to the first website.

As shown in FIG. 3D, and by reference number 350, user device 105 may detect a trigger for providing targeted content. In some implementations, as part receiving the content for the second website, user device 105 may receive a code to obtain targeted content for the second website. User device 105 may use the code to obtain the targeted content. For example, based on the code, user device 105 may provide a request for the targeted content. After receiving the targeted content, user device 105 may determine the content category of the targeted content.

In some implementations, based on the information user device 105 previously provided to content server 205, content server 205 may identify user device 105 and may determine the targeted content to be provided to user device 105. In some implementations, the targeted content may be a website previously accessed by user device 105 (e.g., the first website).

As shown in FIG. 3D, and by reference number 355, user device 105 may determine active applications. In some implementations, based on receiving the request, user device 105 may determine the active applications executing on user device 105. For example, user device 105 may use process handler 150 to determine the active applications. For instance, process handler 150 may communicate with application layer 110 to determine the active applications.

As shown in FIG. 3E, and by reference number 360, user device 105 may determine whether an active application is sharing current content with one or more additional devices. In some implementations, user device 105 may determine whether the current content, displayed by user device 105, is being shared the one or more additional devices. As shown in FIG. 3E, the one or more additional devices may include a desktop, a laptop, and/or a tablet computer. The active application may include a video conferencing application.

As shown in FIG. 3E, and by reference number 365, user device 105 may prevent the targeted content from being displayed if an active application is sharing the current content. In some implementations, user device 105 may store the targeted content if an active application is sharing the current content. In this regard, the targeted content may subsequently be retrieved and displayed.

As shown in FIG. 3F, and by reference number 370, user device 105 may determine the period of time associated with providing the content category. In some implementations, if an active application is not sharing the current content, user device 105 may determine the content category of the targeted content and use the content category to identify the period of time.

As shown in FIG. 3F, and by reference number 375, user device 105 may determine whether a current time is included in the period of time. For example, user device 105 may determine whether the targeted content is to be provided. For instance, if the content category is professional and the period of time 9AM-5PM, user device 105 may determine whether the current time is within 9AM and 5PM.

As shown in FIG. 3F, and by reference number 380, user device 105 may prevent the targeted content from being displayed if the current time is not included in the period of time. For example, if the targeted content is received outside of the period of time, user device 105 may determine that the targeted content is not to be displayed because the targeted content is not related to the period of time. Accordingly, the targeted content will most likely be ignored and will not be accessed by a user of user device 105.

The targeted content may be stored for retrieval during a period of time that corresponds to the content category of the targeted content. For example, when the targeted content corresponds to a professional content category, and the targeted content is received during the period of time for content corresponding to a personal content category, the targeted content may be stored and subsequently retrieved during the period of time that corresponds to the professional content category. In such instances, user device 105 may select from the memory (of user device 105) alternate targeted content that corresponds to the personal content category.

As shown in FIG. 3G, and by reference number 385, user device 105 may provide the targeted content if the current time is included in the period of time.

As indicated above, FIGS. 3A-3G are provided as examples of implementations described herein. Other examples may differ from what is described with regard to FIGS. 3A-3G. The number and arrangement of devices shown in FIGS. 3A-3G are provided as an example. A network, formed by the devices shown in FIGS. 3A-3G may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and/or various combinations of the foregoing.

There may be additional devices (e.g., a large number of devices), fewer devices, different devices, or differently arranged devices than those shown in FIGS. 3A-3G. Furthermore, two or more devices shown in FIGS. 3A-3G may be implemented within a single device, or a single device shown in FIGS. 3A-3G may be implemented as multiple, distributed devices. Additionally, or alternatively, a set of devices (e.g., one or more devices) shown in FIGS. 3A-3G may perform one or more functions described as being performed by another set of devices shown in FIGS. 3A-3G.

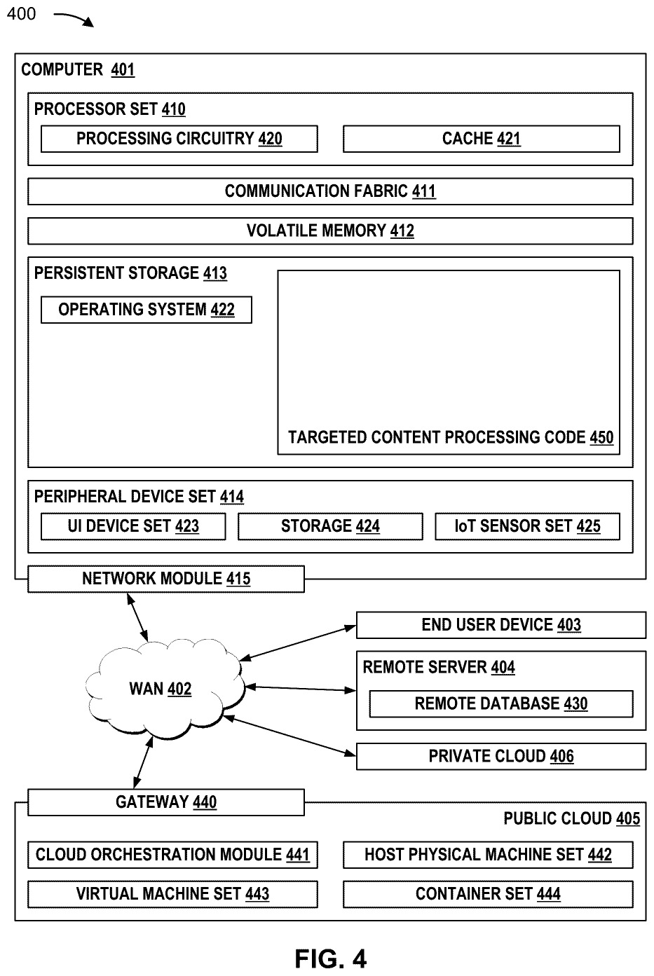

FIG. 4 is a diagram of an example computing environment 400 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as targeted content processing code 450. In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401) and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

FIG. 5 is a diagram of example components of a device 500, which may correspond to user device 105. In some implementations, user device 105 may include one or more devices 500 and/or one or more components of device 500. As shown in FIG. 5, device 500 may include a bus 510, a processor 520, a memory 530, a storage component 540, an input component 550, an output component 560, and a communication component 570.

Bus 510 includes a component that enables wired and/or wireless communication among the components of device 500. Processor 520 includes a central processing unit, a graphics processing unit, a microprocessor, a controller, a microcontroller, a digital signal processor, a field-programmable gate array, an application-specific integrated circuit, and/or another type of processing component. Processor 520 is implemented in hardware, firmware, or a combination of hardware and software. In some implementations, processor 520 includes one or more processors capable of being programmed to perform a function. Memory 530 includes a random access memory, a read only memory, and/or another type of memory (e.g., a flash memory, a magnetic memory, and/or an optical memory).

Storage component 540 stores information and/or software related to the operation of device 500. For example, storage component 540 may include a hard disk drive, a magnetic disk drive, an optical disk drive, a solid state disk drive, a compact disc, a digital versatile disc, and/or another type of non-transitory computer-readable medium. Input component 550 enables device 500 to receive input, such as user input and/or sensed inputs. For example, input component 550 may include a touch screen, a keyboard, a keypad, a mouse, a button, a microphone, a switch, a sensor, a global positioning system component, an accelerometer, a gyroscope, and/or an actuator. Output component 560 enables device 500 to provide output, such as via a display, a speaker, and/or one or more light-emitting diodes. Communication component 570 enables device 500 to communicate with other devices, such as via a wired connection and/or a wireless connection. For example, communication component 570 may include a receiver, a transmitter, a transceiver, a modem, a network interface card, and/or an antenna.

Device 500 may perform one or more processes described herein. For example, a non-transitory computer-readable medium (e.g., memory 530 and/or storage component 540) may store a set of instructions (e.g., one or more instructions, code, software code, and/or program code) for execution by processor 520. Processor 520 may execute the set of instructions to perform one or more processes described herein. In some implementations, execution of the set of instructions, by one or more processors 520, causes the one or more processors 520 and/or the device 500 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 5 are provided as an example. Device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

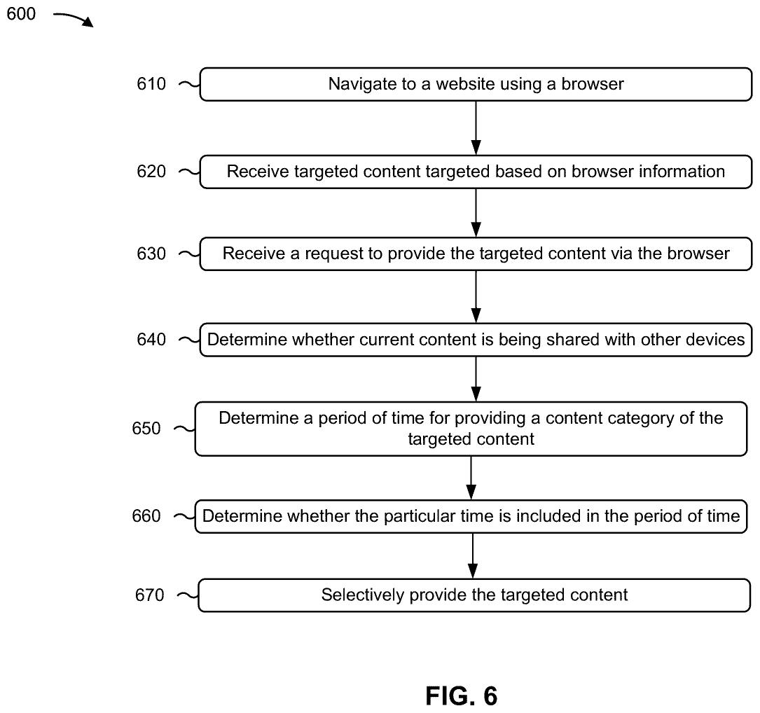

FIG. 6 is a flowchart of an example process 600 associated with providing targeted content. In some implementations, one or more process blocks of FIG. 6 may be performed by a user device (e.g., user device 105). Additionally, or alternatively, one or more process blocks of FIG. 6 may be performed by one or more components of device 500, such as processor 520, memory 530, storage component 540, input component 550, output component 560, and/or communication component 570.

As shown in FIG. 6, process 600 may include navigating to a website using a browser (block 610). For example, the user device may navigate to a website using a browser, as described above.

As further shown in FIG. 6, process 600 may include receiving targeted content targeted based on browser information (block 620). For example, the user device may receive targeted content targeted based on browser information, as described above.

As further shown in FIG. 6, process 600 may include receiving a request to provide the targeted content via the browser (block 630). For example, the user device may receive a request to provide the targeted content via the browser, as described above.

As further shown in FIG. 6, process 600 may include determining whether current content is being shared with other devices (block 640). For example, the user device may determine whether current content is being shared with other devices, as described above.

As further shown in FIG. 6, process 600 may include determining a period of time for providing a content category of the targeted content (block 650). For example, the user device may determine a period of time for providing a content category of the targeted content, as described above.

As further shown in FIG. 6, process 600 may include determining whether the particular time is included in the period of time (block 660). For example, the user device may determine whether the particular time is included in the period of time, as described above.

As further shown in FIG. 6, process 600 may include selectively providing the targeted content (block 670). For example, the user device may selectively provide the targeted content, as described above.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method for providing targeted content, the computer-implemented method comprising:
navigating to a website using a browser of a device;
receiving, based on navigating to the website, targeted content that is targeted based on browsing information;
receiving, based on navigating to the website and at a particular time, a request to provide the targeted content via the browser;
determining whether content, on a display of the device, is being shared with one or more additional devices;
determining a period of time for providing a content category of the targeted content;
determining whether the particular time is included in the period of time based on determining whether the content is being shared; and
selectively providing the targeted content based on determining whether the current time is included in the period of time,
the targeted content being provided when the current time is included in the period of time, and
the targeted content being prevented from being provided when the current time is not included in the period of time.

2. The computer-implemented method of claim 1, wherein determining whether the current time is included in the period of time comprises:
determining that the content, on the display of the device, is not being shared with the one or more additional devices; and
determining whether the current time is included in the period of time based on determining that the content is not being shared with the one or more additional devices.

3. The computer-implemented method of claim 2, further comprising:
preventing the targeted content from being shared until the current time is included in the period of time.

4. The computer-implemented method of claim 1, wherein determining the period of time associated with providing the content category of the targeted content comprises:
determining that the targeted content is to be provided during a first period of time when the content category is a first content category; and
determining that the targeted content is to be provided during a second period of time when the content category is a second content category.

5. The computer-implemented method of claim 4, wherein the first content category is professional content,
wherein the second content category is personal content, and
wherein the first period of time precedes the second period of time.

6. The computer-implemented method of claim 1, wherein determining whether the content is being shared with the one or more additional devices comprises:
determining whether an application, that shares content, is being executed on the device, wherein the application includes a video conferencing application.

7. The computer-implemented method of claim 1, wherein the particular time is a first particular time,
wherein the website is a first website, and
wherein the computer-implemented method further comprises, prior to navigating to the first website:
navigating to a second website at a second particular time;
determining a classification associated with the second website based on the second particular time;
providing time information identifying the second particular time along with event information regarding events associated with navigating to the second website,
wherein the event information identifies the classification.

8. A computer program product comprising:
one or more computer readable storage media, and program instructions collectively stored on the one or more computer readable storage media, the program instructions comprising:
program instructions to receive a request to provide, to a device, targeted content that is targeted based on browsing history associated with the device;
program instructions to determine applications executing on the device;
program instructions to determine whether at least one of the applications is sharing content, on a display of the device, with one or more additional devices; and
program instructions to selectively:
prevent the targeted content from being provided when the at least one of the applications is sharing content on the display of the device with the one or more additional devices, and
determine a period of time for providing a content category of the targeted content when the at least one of the applications is not sharing content on the display of the device with the one or more additional devices.

9. The computer program product of claim 8, wherein the program instructions to further comprise:
program instructions to determine that the at least one of the applications is not sharing content on the display of the device with the one or more additional devices;
program instructions to determine the period of time associated with providing the content category of the targeted content;
program instructions to determine whether a current time is included in the period of time after determining the period of time; and
program instructions to selectively provide the targeted content based on determining whether the current time is included in the period of time.

10. The computer program product of claim 9, wherein the program instructions to selectively provide the targeted content comprise:
program instructions to determine that the current time is included in the period of time; and
program instructions to provide the targeted content based on determining that the current time is included in the period of time.

11. The computer program product of claim 9, wherein the program instructions to selectively provide the targeted content comprise:
program instructions to determine that the current time is not included in the period of time; and
program instructions to prevent the targeted content from being provided based on determining that the current time is not included in the period of time.

12. The computer program product of claim 8, wherein the program instructions to receive the request to provide the targeted content comprise:
program instructions to navigate to a website using a browser of the device; and
program instructions to receive the request to provide the targeted content based on navigating to the website.

13. The computer program product of claim 8, wherein the program instructions to determine the period of time associated with providing the content category of the targeted content comprise:
program instructions to determine that the targeted content is to be provided during a first period of time when the targeted content is a first content category; and
program instructions to determine that the targeted content is to be provided during a second period of time when the targeted content is a second content category.

14. The computer program product of claim 13, wherein the program instructions further comprise:
program instructions to obtain information regarding different content accessed at different times;
program instructions to determine the first content category and the second content category based on the information regarding the different content; and
program instructions to determine the first period of time and the second period of time based on the different times.

15. A system comprising:
a device configured to:
receive a request to provide, on a display of the device, targeted content that is targeted based on content previously accessed by the device or by another device associated with the device;
determine applications executing on the device;
determine whether at least one application of the applications is an application is sharing content, on the display, with one or more additional devices; and
selectively:
determine that the targeted content is not to be provided on the display when the at least one application is sharing content on the display with the one or more additional devices, and
determine a period of time for providing a content category of the targeted content when the at least one application is not sharing content on the display with the one or more additional devices.

16. The system of claim 15, wherein the device is configured to:
determine that the at least one application is not sharing content on the display with the one or more additional devices; and
determine the period of time based on the at least one application is not sharing content on the display with the one or more additional devices.

17. The system of claim 16, wherein the device is configured to:
determine whether a current time is included in the period of time;
selectively provide the targeted content based on determining whether the current time is included in the period of time,
the targeted content being provided when the current time is included in the period of time, and
the targeted content being prevented from being provided when the current time is included in the period of time.

18. The system of claim 15, wherein the period of time is a first period of time, and
wherein the device is configured to:
determine that the targeted content is to be provided during the first period of time when the content category is a first content category; and
determine that the targeted content is to be provided during a second period of time when the content category is a second content category.

19. The system of claim 18, wherein the device is configured to:
obtain information regarding different content accessed at different times;
determine the first content category and the second content category based on the information regarding the different content; and
determine the first period of time and the second period of time based on the different times.

20. The system of claim 15, wherein the period of time is a first period of time, and
wherein the device is configured to:
determine that the targeted content is to be provided during the first period of time; and
determine that the targeted content is not to be provided during a second period of time.
